(19) United States
(12) Patent Application Publication
(10) Pub. No.: US 2006/0203209 A1
(43) Pub. Date: Sep. 14, 2006

(54) Colour-sequential projection system comprising four primary colours

(75) Inventor: Adrianus Johannes Stephanes Maria De Vaan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/539,976

(22) PCT Filed: Nov. 14, 2003
(86) PCT No.: PCT/IB03/05189

§ 371 Date: Jun. 19, 2005

(30) Foreign Application Priority Data
Dec. 18, 2002 (EP) 02080358.1

(51) Int. Cl. G03B 21/14

(52) U.S. Cl. 353/84

(57) ABSTRACT

A projection display device comprises an illumination system having a light source providing an illumination beam, a colour filter means comprising four different colour filter segments, corresponding to four different primary colours, respectively, for scanning an image display panel with different coloured portions of the illumination beam, and an image display system comprising said image display panel for modulating the coloured portions of the illumination beam with image information and projecting an image on a screen. The device is characterized in that the colour filter segments are arranged to allow simultaneous scanning of said image display panel with at least three of said four primary colours.

The present invention relates to a projection display device comprising an illumination system having a light source providing an illumination beam, a colour filter means comprising four different colour filter segments, corresponding to four different primary colours, respectively, for scanning an image display panel with different coloured portions of the illumination beam, and an image display system comprising said image display panel for modulating the coloured portions of the illumination beam with image information and projecting an image on a screen.

The invention also relates to a colour filter wheel for use in such a projection display device.

The invention also relates to an image display system for use in such a projection display device.

The invention also relates to a method of operating such a projection display device.

Vision is the sense, mediated by the eyes, by which the qualities of an object (such as colour, luminosity, shape and size) constituting its appearance are perceived. Lightness, hue and colourfulness are three sensational parameters in vision. Lightness characterizes the amount of light that a surface is emitting, hue results in naming the colours blue, green, yellow, red, purple, etc. and colourfulness (or saturation) serves for the estimation where a perceived colour can be located between white and the pure spectral colour, provided this later has the same lightness and hue as the examined colour. The saturation grade is usually given by the adjectives attached to the colours, e.g. light green, pastel blue, dark red, faint yellow, etc.

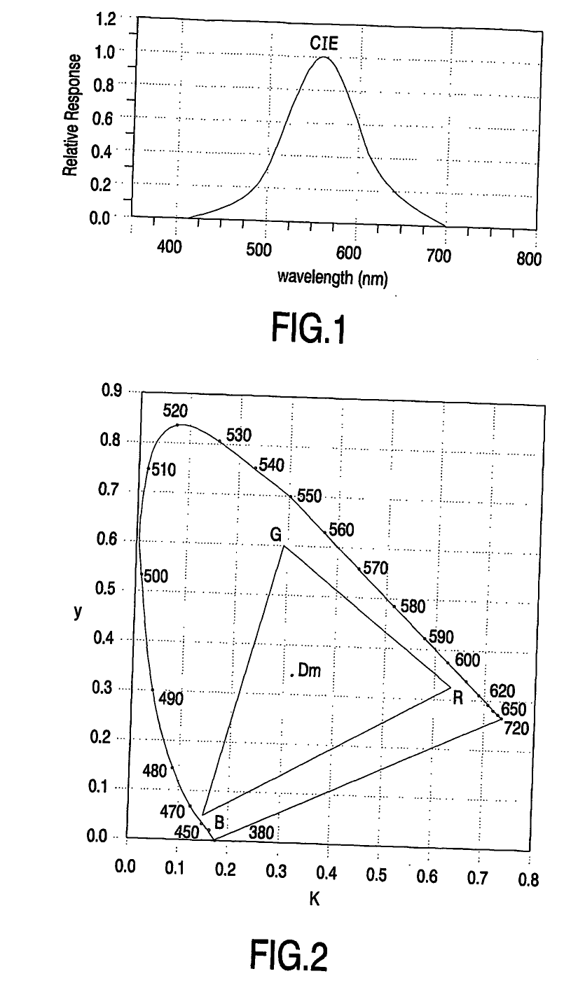

The relative response of the normal human eye to monochromatic light of different wavelengths has been determined experimentally by the International Commission on Illumination (CIE—Commission Internationale de l'Eclairage), and is known as the photopic spectral luminous efficiency function V(λ), which is illustrated in FIG. 1. From this Figure, it is evident that the eye's response to visible light (ca. 400-800 nm) of various wavelengths (colours) generally varies approximately as a gaussian distribution, peaking at 570-580 nm, i.e. yellow light.

The CIE has furthermore defined a standard set of reference colour stimuli, and a standard set of tristimulus values for them; these data constitute the CIE 1931 standard colorimetric observer. The reference-colour stimuli are light of wavelength 700 nm for the red stimulus (R), light of wavelength 546.1 nm for the green stimulus (G) and light of wavelength 435.8 nm for the blue stimulus (B).

The tristimulus values of these three colours were chosen to match the typical white colour. There is, however, an imbalance in the three corresponding amounts (the amount of green being the greatest, and the amount of blue being much smaller).

Red, green and blue are sometimes chosen as primary colours, such that additional colours may be created by combining suitable amounts of these primary colours. The different combinations of primary colour tristimulus values for different colours have been determined experimentally. As three stimuli are assigned to each colour, created accordingly as a combination of three primary colours, a three-dimensional coordinate system would be required in order to represent the actual coordinates of each colour graphically. In order to simplify the graphical data representation (at the expense of losing the lightness information), coordinate transformation and additional calculations may be performed in order to represent the relations between the different colours as the two-dimensional CIE chromaticity diagram, which is shown in FIG. 2.

The x and y coordinates, which are referred to as the chromaticity coordinates, may be calculated from the original tristimulus values X, Y and Z according to the equations below:

$$x = \frac{X}{X + Y + Z} , y = \frac{Y}{X + Y + Z} \qquad ( 1 )$$

The positions of the spectral colours (the spectrum locus) are shown by the curved line and given by the corresponding wavelengths in nm. The points representing non-spectral (pale) colours are inside the area, which is delimited by the curved line. The straight line at the bottom of the chart (the purple line) connects the red and the blue spectral colours, so that non-spectral colours mixed of red and blue (e.g. purple, violet, etc.) are located along this line. The illuminant (the point representing the normal white colour) is located in the middle and is denoted D.

Any colour assigned to a point inside the area, which is delimited by the curved line and the purple line and lies on an imaginary, straight line going through point D, can be mixed by the addition of white D and the spectral colour given by the intersection of the straight line with the curved or purple lines, respectively. If the point of intersection is situated on the purple line, the weighted mixture of red and blue should be used instead of a spectral colour.

The chromaticity diagram only shows the proportions of tristimulus values; hence bright and dim colours having the same tristimulus proportions belong to the same point. For this reason, the illuminant point D also represents grey colours; and orange and brown colours, for example, tend to plot at similar positions to each other. That is why luminance has to be given as additional information for the unambiguous definition of a certain colour.

In colour displays, the displayable colour gamut is limited to a colour triangle, which is spanned by three primary colours, e.g. red, green and blue (as illustrated in FIG. 2). Colours outside this colour triangle, e.g. gold and turquoise (in a case where the primary colours are red, green and blue), cannot be displayed and are consequently clipped towards colours that can be displayed, e.g. more unsaturated yellow and more bluish green. It is known that adding one or more additional primary colours to the three primary colours used in most current applications offers a possibility to expand the displayable colour gamut.

When selecting an additional primary colour, its impact on the luminance and the colour gamut of a display should be taken into account. When considering the luminance alone, a primary colour with a high luminance such as those in the triangle yellow-white-green appears desirable. Regarding the colour gamut, with a view to extend the colour gamut as much as possible, a highly saturated yellow, cyan or magenta would be preferred.

Yellow is furthermore a colour which carries much brightness and is therefore a colour whose absence is easily detected. This is why adding more saturated yellow colours is generally most appreciated from a perceptional point of view. Considering all requirements, a yellow primary would be the best choice of an additional primary colour in a prior-art display system with only red, green, and blue primary colours (RGB-display).

The human eye is very sensitive to yellow light (570 to 580 nm), which is why adding a yellow primary colour would largely improve the overall brightness of a displayed image and the image quality in a RGB-display.

A colour other than yellow could nevertheless be a suitable fourth primary colour if images of some special type were to be displayed. If one had, for instance, a display only showing images of various seas, it would be more advisable to add a turquoise primary colour.

In display technology, the luminance signal is defined as the signal which has the major control over the brightness. The colour signal (chrominance signal) is defined as the signal which carries colour information.

Modem display systems typically create full-colour projected images by projecting three single-colour images. The eye of the viewer integrates these single-colour images to give the perception of a single, full-colour image. Three separate modulators or controllable light sources are often used simultaneously to generate the primary-colour images. Three liquid crystal display (LCD) panels or digital micromirror device (DMD) arrays and appropriate dichroic filters may create, for instance, three primary-colour images using a single light source, or three electron rays in a cathode ray tube may perform, for instance, both the modulator and light source functions to create three primary colour images.

Alternatively, a single modulator is used with a sequential colour light source to sequentially create three primary-colour images. If the light source sequences through the primary colours fast enough, the viewer will not see the sequential single-colour images but will instead see a single full-colour image. A sequential colour light source is generally formed by combining a white light source with a filtering means such as a colour wheel.

The present invention relates to colour projection display devices using the single modulator principle referred to above, in particular colour projection systems which have a colour filter means such as a colour filter wheel.

Projection display devices can be used in both rear and front image projection systems. In a rear projection system, the projection display device projects an image representing television or data graphic information on the rear side of a diffusing transparent screen, whose front side is directed to a viewing audience. In a front projection system, the projection display device projects an image representing television or data graphic information on the front side of a reflecting screen, which front side is directed to a viewing audience.

Such a projection display device typically comprises an illumination system and an image display system having an image display panel for modulating an illumination beam to be supplied by the illumination system with image information. The illumination system typically comprises a light source and an integrator system for forming an illumination beam, typically but not necessarily of white light comprising a plurality of wavelengths.

A colour filter means, such as a colour wheel, is typically present between the light source and the integrator system, said colour wheel including at least one filter for each of the primary colours, typically red, green and blue filters. Red, green and blue light is transmitted through the red, green and blue filters, respectively, while light of other wavelengths is reflected.

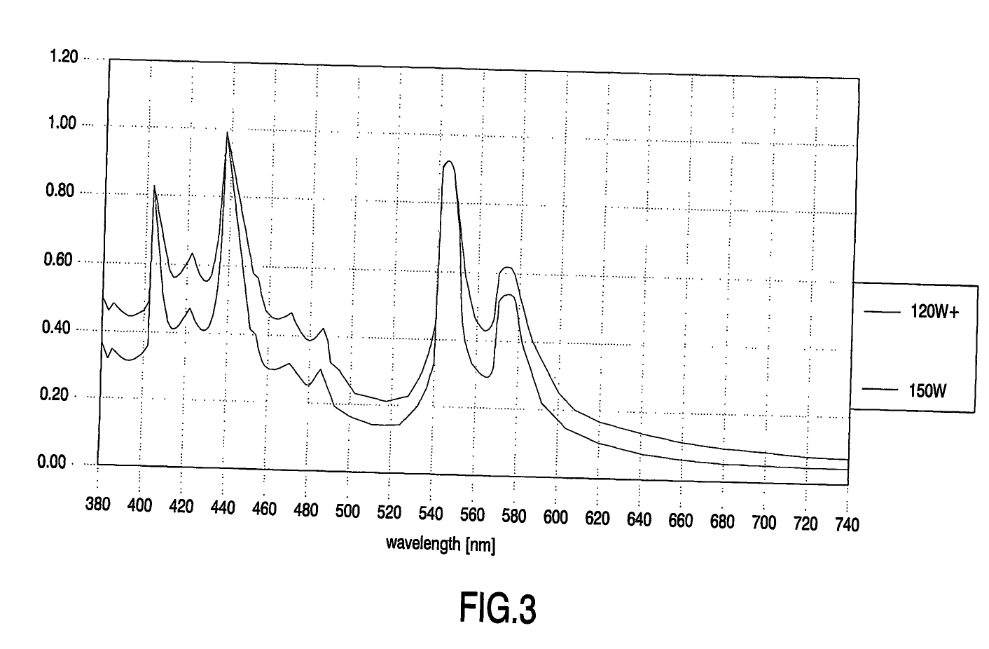

A colour wheel is typically a disk-shaped assembly of dichroic colour filters. FIG. 3 is an illustration of a prior-art colour wheel comprising four colour filter areas (red, green, blue, yellow), which occupy four angular segments of the colour wheel.

During operation, the dichroic filters of a colour wheel, which are either transmissive or reflective, filter the white light to form a primary-colour light beam that changes colours, typically from red to green, from green to blue, from blue to yellow and from yellow to red, and so on, in a rate proportional to the angular speed of the wheel.

Spinning the colour wheel so that each filter passes through the point at which the white light beam strikes the colour wheel generates a sequential primary colour light beam. The colour wheel is typically spun fast enough to create at least one primary colour period for each primary colour during each frame of a video image. Spinning the wheel faster, or using multiple filter segments for one or more of the primary colours, can reduce colour separation artefacts that allow the viewer to detect the sequential colour nature of the display system.

The display panel modulates the coloured illumination beam in accordance with corresponding image information of the colour of the illumination beam incident on the display panel. In order to improve the light efficiency, a reflective polarizer may be present between the colour filter wheel and the display system. The reflective polarizer transmits a portion of the illumination beam having a polarization in a first direction and reflects a portion of the illumination beam having a second polarization in a second direction, perpendicular to the first direction. Furthermore, light recycling means may be present in the projection display device to reuse the reflected light from the reflective polarizer. A dichroic filter can also be used in the colour filter wheel for reflecting a portion of the illumination beam having an undesired colour.

While a sequential colour display system typically costs less to produce than a simultaneous colour display system, images created by a sequential filtered colour display system are not as bright as images created by simultaneous colour display systems using the same light source because only a portion of the light generated by the light source is used to form the image at any given time. When using a four-colour equal-segment filter wheel, each primary colour is produced only ¼ of the time. Additionally, when a sequential filter such as a colour wheel is used, the light during the filter transitions, typically called spoke times, will be a varying mixture of the two filters being changed in and out. This mixed-colour light is typically not used because using the mixed colour light would adversely affect the colour purity of the created image. The addition of more primary colours typically results in an increased number of filter transitions, which may cause colour artefacts during operation.

Projectors which even accept the yellow light have recently been introduced on the market. In these projectors, the yellow part of the spectrum has been added to the red channel, thus changing red into orange. Although this increases the light output by approximately 20% to 30%, it makes these projectors unsuitable for video applications.

High image brightness is one of the major desires of customers in the projection display market. Therefore, a method and a system for increasing the brightness of a projected image are needed.

In spite of the many advantages of using the yellow light from the light source, conventional projection display devices do not use yellow light due to the implied desaturation of the colours. It is accordingly a problem that the use of yellow light in order to obtain increased brightness results in the desaturation of the colours, and this is why other ways of obtaining increased brightness have been developed.

U.S. Pat. No. 6,324,006 discloses a method and display system for using the light passing through the spokes of a colour wheel. The light is a mixed and rapidly changing colour. Adding all of the spoke times produces white, but adding a subset creates colour artefacts. Not all spoke times can be added at the same time without altering the white point of the display. The spoke times are added in a sequence and the sequence is altered over time for the same pixel such that the pixel converges to white over time. The pattern of spoke bits is arranged so that as adjacent spoke bit pixels are added, the net spoke light converges to white. The patterns are also varied so that, as more and more spoke bit periods are turned on, the net spoke light converges to white. Each spoke bit period adds n-LSBs of white light intensity, so as each spoke bit period is added, n-1 LSBs of white light are subtracted from the white data.

A system and a method according to the aforementioned patent application are associated with a great number of shortcomings, disadvantages and limitations: the colour gamut is not expanded, the increase in brightness is modest, the construction of such a display system is complicated and expensive and the method of manufacturing and operating such a display is cumbersome and expensive.

It is an object of the invention to provide a projection display device with an increased brightness compared to a prior art projection display device.

This object is achieved by a projection display device comprising an illumination system having a light source providing an illumination beam, a colour filter means comprising four different colour filter segments, corresponding to four different primary colours, respectively, for scanning an image display panel with different coloured portions of the illumination beam, and an image display system comprising said image display panel for modulating the coloured portions of the illumination beam with image information and projecting an image on a screen, characterized in that the colour filter segments are arranged to allow simultaneous scanning of said image display panel with at least three of said four primary colours.

The measures as defined in claims 2 to 7 constitute particularly preferred embodiments of the invention.

The invention further relates to a colour filter wheel for use in such a projection display device.

The measures as defined in claims 9 to 10 constitute particularly preferred embodiments of the colour wheel.

The invention further relates to an image display system for use in such a projection display device.

It is a further object of the invention to provide a method of operating a projection display device with an increased brightness as compared to the prior-art method.

This object is achieved by the method according to the invention as specified in claim 12.

These and other aspects of the invention are apparent from and will be elucidated with reference to the embodiments described hereinafter.

FIG. 1 is a diagram of the photopic spectral luminous efficiency function V(X).

FIG. 2 is a chromaticity diagram.

FIG. 3 is an illustration of a colour wheel comprising four colour filter areas.

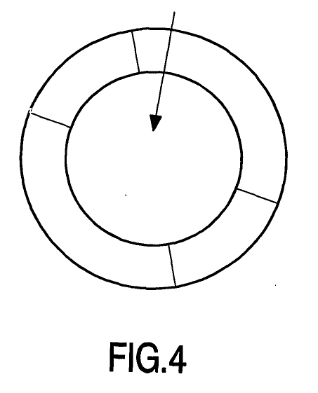

FIG. 4 is a diagram of the spectral characteristics of two UHP lamps.

FIG. 5 is a schematic drawing of an image projection system.

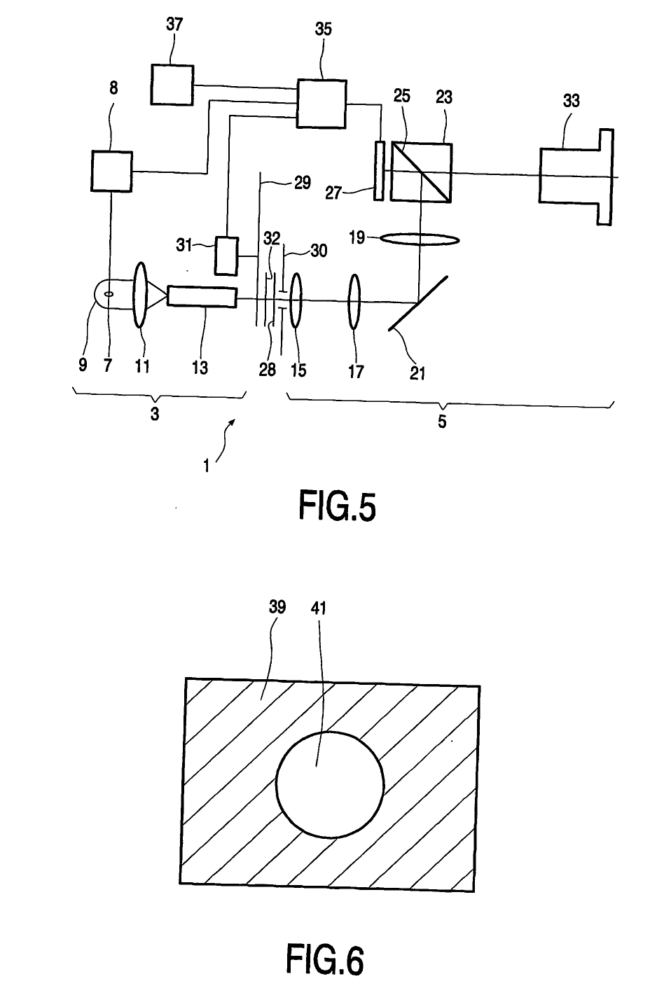

FIG. 6 is a front view of the entrance surface of the optical bar.

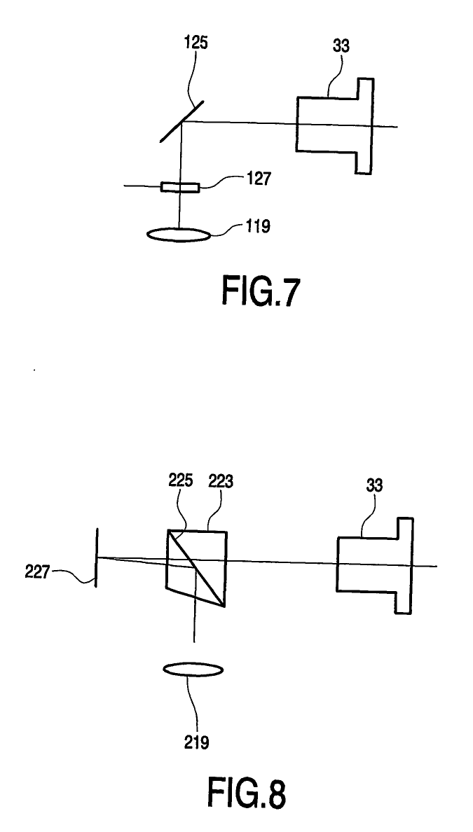

FIG. 7 shows a relevant portion of the projection display according to a first alternative embodiment.

FIG. 8 shows a relevant portion of the projection display according to a second alternative embodiment.

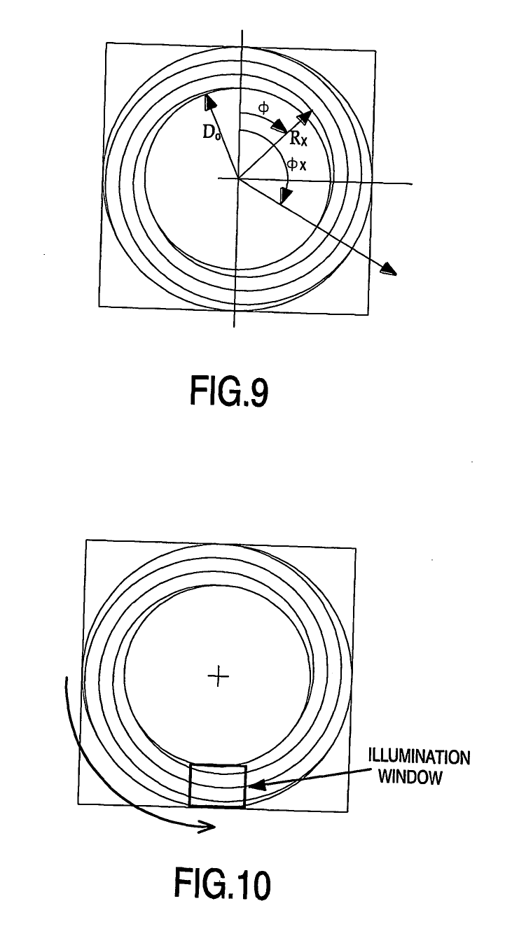

FIG. 9 shows a colour filter wheel according to a first embodiment of the invention.

FIG. 10 shows a colour filter wheel in combination with a rectangular illumination window.

Generally speaking, the invention relates to a projection display device having a spiral-shaped colour wheel for generating moving images over a display panel, wherein in addition to red, blue and green filter segments, the colour wheel comprises a yellow filter segment. In the device according to invention, it is proposed to incorporate a yellow segment in the colour wheel in such a way that the yellow light can be modulated independently and a larger portion of the light from the lamp can be used.

The invention is a new and inventive industrial application wherein a yellow filter means segment is added as a fourth colour band in a scrolling colour-based projection system in a way which allows the yellow light to be used when presenting a first kind of image but not when presenting a second kind of image. The intensity of the yellow light can thus be controlled independently of the intensity of red light. When video images are projected, all yellow light is filtered away or blocked, which results in proper colour reproduction. When data images are projected, the yellow signal can be fed with the same information as the red signal, which results in a higher brightness.

FIG. 4 is a diagram of the spectral characteristics of two UHP lamps. The diagram illustrates the emitted intensity (a.u.) as a function of wavelength (nm) for a 120 W UHP lamp and for a 150 W UHP lamp. The light emission spectrum of a projection lamp is a very important factor in designing all spectral components in a projection system.

At 120 W power, the intensity of the emitted red light is lower than the intensity of the emitted blue light. Since most glass materials have a lower relative transmission of blue light than of red light, the light output between blue light and red light may be balanced in most projection systems. A problem which is associated with such balancing arrangements is that the system will still project by far too much green light.

In the case of front projection systems, the highest possible brightness is preferred to proper colour reproduction. Many front projectors for professional applications are therefore designed so that the intensity of green light coming from the projection lens is as high as possible, which results in an incorrect representation of the projected colour images. A human face will look, for instance, green when projected by such a system.

For video applications, obtaining the proper colours is of extreme importance, and often more important than obtaining a high brightness. In projectors which are intended for video applications, the light intensity of the individual colour channels are adjusted accordingly. For a 120 W UHP lamp, this implies that about 40% of the light intensity may be lost in order to obtain the proper colour.

The invention accordingly relates to a method of operating a projection display device, the method comprising the steps of discriminating between at least a first type of image and a second type of image to be presented, for an image of said first type, projecting the image using a first set of the primary colours of the colour filter means, and for an image of said second type, projecting the image using a second set of the primary colours of the colour filter means. A particularly preferred realization of the method is achieved when the first and second types of images are data images and video images, respectively, and when data images are displayed using all of said four different primary colours, and wherein video images are displayed using three of said four primary colours.

Some parts of the emitted electromagnetic spectrum are furthermore not used in the projection system. Ultraviolet (UV) and infrared (IR) light are not visible to the human eye and only give rise to lifetime problems and heat problems in the optical system. These parts of the electromagnetic spectrum are ideally filtered out of the light beam in an earliest possible stage.

The UHP lamp has furthermore a very unlucky peak at 575 nm (yellow light). This light is typically not usable because it only dissaturates the green and red colours. Said yellow peak furthermore contains a lot of light, which due to tolerances on filter means such as dichroic mirrors causes colour shifts, either in the green or in the red direction.

In order to prevent these negative side effects, which are associated with the yellow peak, said yellow light needs to be carefully filtered out of the light path.

A preferred embodiment of the invention is a scrolling colour architecture, wherein the yellow colour can be used without drastically incrementing the number of optical components. Scrolling colour systems based on a spiral-shaped colour wheel are perfectly suitable because only a yellow spiral filter needs to be added to the colour wheel.

Several solutions exist, which describe scrolling colour bar scanners to be used in colour-sequential “scrolling colour” type projection systems. As will be recognized by the skilled person, there are solutions with colour wheels that look attractive with regard to material content and compactness. This patent application describes a four-primary colour spiral wheel design.

FIG. 5 is a schematic drawing of an image projection system 1 comprising an illumination system 3 for supplying an illumination beam and an image display system 5 for modulating the illumination beam. The illumination system 3 comprises a light source 7, a reflector 9, a condenser lens 11 and a light-guiding means 13, for example, a bar of optically transparent material. The light source is electrically coupled to a control unit 8. The reflector ensures that the greater part of the light emitted by the light source 7 in a direction away from the illumination system as yet reaches the image display system 5. The illumination beam generated by the illumination system 3 is incident on the image display system 5. The image display system 5 comprises a reflective display panel 27, a polarising beam-splitting (PBS) prism 23, relay lenses 15,17,19, a mirror 21 and a projection lens 33. The image projection system 1 also comprises control means 35 and a colour filter wheel 29 coupled to an electric motor drive 31. The colour filter wheel 29 is positioned between the exit window of the optical bar 13 and the image display system 5. A rectangular window 30 is positioned between the colour filter wheel 29 and the image display system 5 for providing, in combination with a spiral-shaped colour filter pattern on the colour wheel 29, a rectangular coloured scanning illumination beam on the reflective display panel 27. Furthermore, the image projection system 1 comprises a reflective polarizer, for example, a wired grid polarizer 28 as can be ordered from Moxtek. The reflective display panel 27 is, for example, a reflective liquid crystal on silicon (LCOS) display panel.

In operation, light from the light source 7 and the reflector 9 is coupled into the optical bar 13 via a lens 11 and an entrance surface and coupled out of the optical bar via an exit surface. A front view of the entrance surface of the optical bar is shown in FIG. 6.

FIG. 6 shows an entrance surface of the optical bar 13. The entrance surface is covered with a reflective layer 39 except for an annular opening 41 around the longitudinal axis of the optical bar 13. The ratio between the area of the opening in the reflective layer and the area of the reflective layer is preferably larger than 5:1. This ratio depends, for example, on the arc length of an incandescent light source and can be found experimentally by a skilled person by optimising the light output of the image projection system 1. The optical bar 13 forms an illumination beam at the exit surface. The illumination beam is incident on a dichroic filter portion of the colour wheel 29.

The arrangement of the rotating spiral-shaped dichroic colour filter 29 and the rectangular illumination window 30 provides an illumination beam having red, green, blue and yellow portions with a rectangular cross-section in the propagation direction of the illumination beam, simultaneously scanning one or more lines of the display panel 27 so that all the lines are consecutively illuminated by the red, green, blue and yellow portions of the illumination beam. The colour wheel 29 comprises four filter portions for transmitting red, green, blue and yellow light simultaneously. The dichroic filter portion of the colour wheel 29 reflects the undesired portion of the illumination beam, not having the proper colour, back to the exit surface of the optical bar 13. Inside the optical bar 13, a large portion of this reflected light is reflected by means of the reflective layer 39 at the entrance surface and can be used again. In the first projection device 1, the portion of the illumination beam which does not have the desired characteristics is thus recycled and can be used again for illumination of the LCOS panel 27.

The dichroic filter portion of the colour filter wheel 29 transmits the portion of the illumination beam having the predetermined colour to the reflective polarizer 28. The reflective polarizer 28 transmits only a portion of the beam having a polarisation directed in a first direction to the PBS prism 23 and reflects a portion of the illumination beam having a polarisation directed in a second direction perpendicular to the first direction via the colour filter wheel 29 back towards the optical bar 13. In this arrangement, a portion of the illumination beam not having the desired characteristic is recycled and can then be used again for illumination of the LCOS display 27. In order to improve the recycle efficiency, a quarter-wave plate 32 can be placed between the colour wheel 29 and the reflective polarizer 28 to rotate the polarisation of the reflected portion of the illumination beam to the first polarisation direction. The relay lenses 15,17,19 guide the predetermined portion of the illumination beam towards the entrance side of the PBS prism 23. The beam-splitting layer 25 of the PBS prism 23 reflects the portion of the illumination beam having the polarisation in the first direction towards the LCOS panel 27. The LCOS panel 27 reflects the illumination back to the PBS prism 23 and rotates the polarisation direction of the illumination beam in conformity with the image information related to the instant colour of the illumination beam. The polarising beam-splitting layer 25 transmits a first portion of the reflected modulated illumination beam towards the projection lens 33 and reflects a second portion of the reflected illumination beam back to the optical bar 13. The light modulated by the image panel 27 is projected on a screen (not shown) by means of a projection lens system represented for the sake of simplicity by a single projection lens 33.

Instead of a reflective liquid crystal display panel, a known transmissive liquid crystal display panel 127 and a folding mirror 125 can be applied in the projection display device. FIG. 7 shows a relevant portion of the projection display device comprising an arrangement of the transmissive liquid crystal display panel 127 and the folding mirror 125 positioned between the relays 119 and the projection lens 33. The transmissive liquid crystal display panel 127 and the folding mirror 125 replaces the reflective LCOS panel 27 and the beam-splitting prism 25 in the projection display device as shown in FIG. 5. In operation, the arrangement of the rotating spiral-shaped dichroic colour filter 29 and the rectangular illumination window 30 provides an illumination beam having red, green, blue and yellow portions with a rectangular cross-section in the propagation direction of the illumination beam, simultaneously scanning one or more lines of the display panel 27 so that all the lines are consecutively illuminated by the red, green, blue and yellow portions of the illumination beam. The portions of the illumination beam incident simultaneously on the transmissive liquid crystal display panel are modulated in conformity with image information. The modulated portions of the illumination beam are projected on a screen (not shown) by the projection lens 33.

Alternatively, instead of a reflective display panel and a prism 25, a known digital micromirror display (DMD) panel and a total internal reflection (TIR) prism can be used. FIG. 8 shows a relevant portion of the projection display device comprising a DMD display panel 227 and a TIR prism 225 positioned between the relays 119 and the projection lens. The DMD display panel 227 and the TIR prism 225 replace the reflective liquid crystal display device 27 and the prism 25 in the projection display device as shown in FIG. 5. In operation, the portions of the illumination beam incident simultaneously on the DMD panel are deflected in conformity with image information. The deflected portions of the illumination beam are projected on a screen (not shown) by the projection lens 33. In the case of a DMD based projection system, the polarizer 28 and the rotating element 32 can be omitted.

FIG. 9 is a schematic illustration of a colour wheel according to a first embodiment of the invention. The colour wheel of FIG. 9 comprises four segments having dichroic colour filters 91, 92, 93, 94 for transmitting red, green blue and yellow light. The yellow segment has the advantage that the brightness of the projected image can be enhanced. The invention makes use of colour wheels that are manufactured from spiral-shaped dichroic mirrors. The intersections 95, 96, 97, 98 of the filter portions 91, 92, 93, 94 can be found by applying formula (2) and setting the phase for each intersection, Φ₁, Φ₂, Φ₃ and Φ₄ equal to 0°, 90°, 180°, 270°, respectively, in equation 2 below.
Rₓ=D₀+α(Φ+Φₓ) (2)
wherein Rₓ is the distance from the intersection x to the centre of the wheel between the colours, D₀ is the distance between the illumination window and the centre of the wheel, α is a Constant, Φ is the angle of the wheel and Φₓ is the phase of the intersection x.

Each individual intersection can be found by taking another phase Φₓ in the above formula. Using the formula (2) to design the individual intersections has the advantage that the individual colour stripes obtain the same height over the illumination window.

The stripes of the four individual colours does not necessarily have to be equal in height and/or symmetrical in size and/or shape. The design of the colour filter segments is ultimately an optimisation problem involving considerations relating to white balancing, brightness, colour representation and system efficiency.

FIG. 10 shows a colour filter wheel 29 in combination with a rectangular illumination window 103. In operation, the arrangement of the rotating spiral-shaped dichroic colour filter portions 91, 92, 93, 94 and the rectangular illumination window 30 provides an illumination beam having red, green, blue and yellow portions with a rectangular cross-section in the propagation direction of the illumination beam, simultaneously scanning one or more pixels of the display panel 27 so that all the pixels are consecutively illuminated by the red, green, blue and yellow portions of the illumination beam.

Also versions with red, green, blue, cyan or red, green, blue, yellow, cyan or red, green, blue, yellow, cyan and magenta segments can be made.

In order to provide a colour filter wheel which can be easily manufactured, the dichroic filters consist of cholesteric layers. This is advantageous because the use of cholesteric colour filters allows a relatively cheap method of manufacturing the colour filter wheel. Cholesteric filters are known per se from WO 00/34808, which discloses a method of manufacturing patterned colour filters. The method comprises the steps of a) providing a layer of a cholesterically ordered material comprising a quantity of a convertible compound which in its non-converted and in its converted state determines the pitch of the cholesterically ordered material to a different extent, in which the conversion of said compound may be induced by radiation, b) irradiating the layer in accordance with a predetermined spiral pattern so that at least a part of the convertible compound in the irradiated parts of the layer is converted, c) polymerizing and/or cross-linking the cholesterically ordered material to form a three-dimensional polymer. The convertible compound preferably comprises an isomerizable, chiral compound. Polymerisation and/or cross-linking are preferably induced by irradiation using electron-beam radiation or actinic radiation.

Other shapes of “colour wheels” are possible, such as rotating drums or polygons (polygon mirrors). The article “51.4: Color-Sequential LcoS Projector with a Rotating Drum” by Matthew S. Brennesholtz, published in SID 02 DIGEST pp. 1-4, and herein enclosed by reference, discloses projection systems wherein the colour wheel is replaced with a rotating colour drum. The cross-section of a rotating drum along the direction of rotation is preferably a circle or a polygon, but other shapes are also conceivable.

Circular drums have the advantage that light recycling can be achieved using an illumination procedure wherein light bounces back into the integrator rod. The polygon drum has the advantage that it is easier to manufacture.

Hence, a projection display device and a method is provided wherein increased brightness can be obtained for an image of a first type for which increased brightness is desired, while the colour representation for an image of a second type is conserved.

The device according to the present invention may be realized, for example, as a separate, stand-alone unit, or may alternatively be included in, or combined with, other equipment.

The invention has mainly been described above with reference to a main embodiment. However, embodiments other than the one disclosed above are equally possible within the scope of the invention, as defined by the appended patent claims. All terms used in the claims are to be interpreted according to their ordinary meaning in the technical field, unless explicitly defined otherwise herein. All references to “a/an/the [element, means, component, member, unit, step, etc.]” are to be interpreted openly as referring to at least one instance of said element, means, component, member, unit, step, etc. The steps of the methods described herein do not have to be performed in the exact order disclosed, unless explicitly specified.

1. A projection display device comprising
an illumination system having a light source providing an illumination beam,
a colour filter means comprising four different colour filter segments, corresponding to four different primary colours, respectively, for scanning an image display panel with different coloured portions of the illumination beam, and
an image display system comprising said image display panel for modulating the coloured portions of the illumination beam with image information and projecting an image on a screen, characterized in that the colour filter segments are arranged to allow simultaneous scanning of said image display panel with at least three of said four primary colours.

2. A projection display device as claimed in claim 1, wherein the colour filter means is arranged to allow simultaneous scanning of said image display panel with at least four of said four primary colours.

3. A projection display device as claimed in claim 1 or 2, wherein the colour filter means is a colour wheel.

4. A projection display device as claimed in claim 1 or 2, wherein the colour filter means is a colour drum.

5. A projection display device as claimed in claim 1 or 2, wherein the colour filter means is a polygon mirror.

6. A projection display device as claimed in any one of claims 3 to 5, wherein the colour filter segments are spiral-shaped.

7. A projection display device as claimed in any one of the preceding claims, wherein three of the primary colours are chosen from the set of red, green, blue, yellow, cyan and magenta.

8. A colour filter wheel for use as said colour filter means in a projection display device as claimed in any one of claims 1 and 2.

9. A colour filter wheel as claimed in claim 8, wherein the colour filter segments are spiral-shaped.

10. A colour filter wheel as claimed in claim 9, with said projection device having an illumination window for transmitting said illumination beam to said colour filter segments, the distance from the intersection between two adjacent colour filter segments to the centre of said colour wheel is determined by the equation
Rₓ=D₀+α(Φ+Φₓ)
wherein Rₓ is the distance from the intersection x to the centre of the wheel between the colours, D₀ is the distance between the illumination window and the centre of the wheel, α is a constant, Φ is the angle of the wheel and Φₓ is the phase of the intersection x.

11. An image display system for use in a projection display device as claimed in any one of claims 1 to 7, wherein the display system is arranged to discriminate between at least a first type of image and a second type of image to be presented; for an image of said first type, projecting the image using a first set of the primary colours of the colour filter means; and for an image of said second type, projecting the image using a second set of the primary colours of the colour filter means.

12. A method of operating a projection display device as claimed in any one of claims 1 to 7, the method comprising the steps of:
discriminating between at least a first type of image and a second type of image to be presented,
for an image of said first type, projecting the image using a first set of the primary colours of the colour filter means,
for an image of said second type, projecting the image using a second set of the primary colours of the colour filter means.

13. A method as claimed in claim 12, wherein the first and second types of images are data images and video images, respectively.

14. A method as claimed in claim 13, wherein data images are displayed, using all of said four different primary colours, and wherein video images are displayed, using three of said four primary colours.
